(19) United States
(12) Patent Application Publication
(10) Pub. No.: US 2025/0301279 A1
(43) Pub. Date: Sep. 25, 2025

(54) GROUND-BASED DETECTION AND AVOIDANCE OF AERIAL OBJECTS FOR A LOCATION

(71) Applicant: Telefonaktiebolaget LM Ericsson (publ), Stockholm (SE)

(72) Inventors: Hans Bertil RÖNNEKE, Kungsbacka (SE); Hans MATTSSON, Mölndal (SE); Shabnam SULTANA, Montreal (CA); Stephen R. HAYES, Flower Mound, TX (US)

(21) Appl. No.: 18/863,436

(22) PCT Filed: May 5, 2023
(86) PCT No.: PCT/IB2023/054712

§ 371 Date: Nov. 6, 2024

Related U.S. Application Data
(60) Provisional application No. 63/339,380, filed on May 6, 2022.

(51) Int. Cl. H04W 4/021; H04W 4/44

(52) U.S. Cl. CPC H04W 4/021; H04W 4/44

(57) ABSTRACT

A first communication device can determine that a second communication device is within an area. The first communication device can determine an identifier of the second communication device. The first communication device can transmit a message to the second communication device using the identifier.

### TECHNICAL FIELD

The present disclosure is related to wireless communication systems and more particularly to ground-based detection and avoidance of aerial objects for a location (e.g., an arena).

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

The management and control of drones can be referred to as Unmanned Aerial System Traffic Management (“UTM”). Governmental administrations (e.g., the US Federal Aviation Administration (“FAA”)), together with industrial parties have investigated the regulation of drones in an international Global UTM Association (“GUTMA”) organization and a Joint Activity GUTMA & Global System for Mobile Communication (“ACJA”) organization.

The commercial applications and opportunities for unmanned aircraft system (“UAS”) operations (particularly at low altitudes, across a myriad of sectors from inspection, to survey, to monitoring, and to package delivery) present enormously enticing incentives and business cases for an operating construct that allows for these operations within the regulatory, operational, and technical environment that includes the National Airspace System (“NAS”). UAS operational needs and expected benefits are driving public and private stakeholder partnerships, led by the FAA and National Aeronautics and Space Administration (“NASA”), to develop and continually mature a Concept of Operations (“ConOps”) for UTM. This vision for UAS operations engenders a common desire to realize innovative solutions through public-private partnerships and the leveraging of technologies in support of emerging opportunities while ensuring safety, security, efficiency, and equity of the NAS are maintained to the highest of standards.

### SUMMARY

According to some embodiments, a method of operating a first communication device is provided. The method includes determining a second communication device is within an area. The method further includes determining an identifier of the second communication device. The method further includes transmitting a message to the second communication device using the identifier.

According to other embodiments, a method of operating a second communication device is provided. The method includes receiving a first message from a first communication device associated with an area. The method further includes transmitting a portion of the first message to a third communication device. The method further includes, responsive to transmitting the portion of the first message, receiving a second message from the third communication device. The method further includes modifying operation of the second communication device based on the second message.

According to other embodiments, a method of operating a third communication device is provided. The method can include receiving a first message from a first communication device associated with an area. The method can further include, responsive to receiving the first message, determining instructions for operating a second communication device in the area based on the first message. The method further includes transmitting a second message to the second communication device, the second message including the instructions.

According to other embodiments, a communication device, network node, system, host, computer program, or computer program product is provided to perform one of the above methods.

According to other embodiments, a ground based system may provide information associated with a specific area to an unmanned aircraft system (“UAS”) including an unmanned aerial vehicle (“UAV”) in the specific area.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5th generation (“5G”) network;

FIG. 2 is a block diagram illustrating an example of 5G network for ground based detection and avoidance (“DAA”) in accordance with some embodiments;

FIG. 3 is a signal flow diagram illustrating an example of ground-based DAA in accordance with some embodiments;

FIG. 4 is a flow chart illustrating an example of operations performed by a first communication device (e.g., an area airspace manager (“AAM”)) in accordance with some embodiments;

FIG. 5 is a flow chart illustrating an example of operations performed by a second communication device (e.g., an unmanned aerial vehicle (“UAV”)) in accordance with some embodiments;

FIG. 6 is a flow chart illustrating an example of operations performed by a third communication device (e.g., a UAV controller (“UAV-C”)) in accordance with some embodiments;

FIG. 7 is a block diagram of a communication system in accordance with some embodiments;

FIG. 8 is a block diagram of a user equipment in accordance with some embodiments FIG. 9 is a block diagram of a network node in accordance with some embodiments;

FIG. 10 is a block diagram of a host computer communicating with a user equipment in accordance with some embodiments;

FIG. 11 is a block diagram of a virtualization environment in accordance with some embodiments; and

FIG. 12 is a block diagram of a host computer communicating via a base station with a user equipment over a partially wireless connection in accordance with some embodiments in accordance with some embodiments.

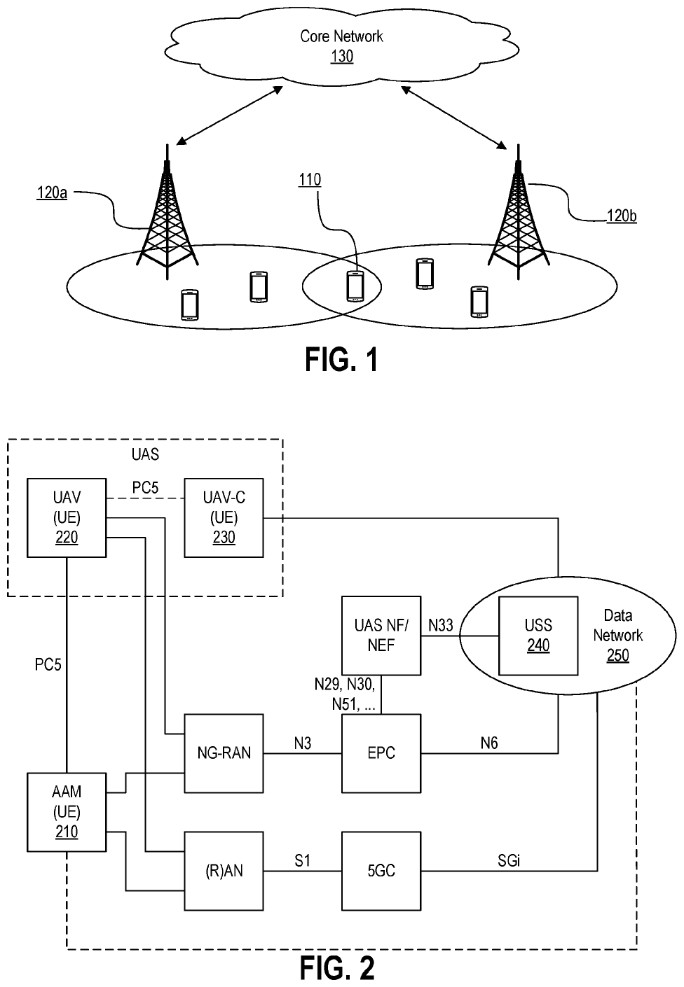

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

There currently exist certain challenges. In some examples, an unmanned aerial system traffic management (“UTM”) can handle a large number of unmanned aerial systems (“UAS”) across a large area. However, the UTM is unable to provide precise instructions to a UAS based on a small area in which the UAS is flying.

Certain aspects of the disclosure and their embodiments may provide solutions to these or other challenges. Various embodiments herein describe establishing a direct communication between a ground system and one or more UAS based on their Remote identifiers (“IDs”). In some examples, the ground system is associated with a specific location such as an arena or a specific area. After communication is established, the ground system can influence the steering and control of each UAS (e.g., to help the UAS detect and avoid obstacles). A UAS can refer to a pair of entities, for example a flying drone (e.g., an unmanned aerial vehicle (“UAV”)) and an associated drone controller (e.g., a UAV Controller (“UAV-C”).

In some embodiments, it is a regulation requirement that UASs must have a Remote ID that is detectable for an observer.

In additional or alternative embodiments, the ground system is able to communicate with the UAS even when the UAS is out of 3^{rd} Generation Partnership Program (“3GPP”) coverage. It can be sufficient that the ground system (sometimes referred to herein as an Area Airspace Manager (“AAM”) has (fixed) internet connectivity to a UAS Service Supplier (“USS”), which may have a repository of Remote IDs and their current/last known locations.

In some embodiments, the term “unmanned aerial vehicle (“UAV”)-to-Everything (“U2X”) communication” is used to refer to communications to support U2X services leveraging the Uu interface and/or a PC5 (e.g., sidelink) reference points. U2X services are realized by various types of U2X applications (e.g., UAV-to-UAV (“U2U”) and UAV-to-Network (“U2N”).

In additional or alternative embodiments, the term “U2X message” is used to refer to a dedicated messaging type of U2X service (e.g., Broadcast Remote Identifier (“ID”) messages.

In additional or alternative embodiments, the term “U2X service type” is used herein to refer to a type of U2X service, which is identified by, for example Intelligent Transport Systems Application Identifier (“ITS-AID”), Provider Service Identifier (“PSID”), or Application Identifier (“AID”).

Various embodiments herein provide a network-assisted (e.g., ground based) Detection and Avoidance (“DAA”) procedure. In some examples, the procedure is applicable to a specific area, such as a stadium or arena where drones are used (e.g., for filming an event). In some embodiments, a ground-based entity detects UAVs in areas such as stadium/arena and provides local policies to the UAS to, for example, avoid the UAVs crashing into each other, into a roof, or a structure. In additional or alternative embodiments, a ground-based entity detects UAVs in areas such as stadium/arena and provides local policies to the UAS to indicate allowed flying zones. In some examples, the operations apply to a specific outdoor area (e.g., an event) where specific measures to avoid collision between drones are established locally.

FIG. 2 illustrates an example of a 5th generation system (“5GS”) for with a ground-based system (Area Airspace Manager (“AAM”) 210) for avoiding detection and avoidance for a UAV 220 in a specific area.

In some embodiments, the arena/area has a ground-based entity (e.g., the AAM 210. The AAM 210 can include one or more communication devices (sometimes referred to herein as user equipments (“UEs”) enabled to use PC5. The AAM 210 may also have a direct connection to the Data Network (“DN”) (250.

In additional or alternative embodiments, for the applicable airspace of the area/arena the AAM 210 may define local DAA rules for correspondingly located UAVs 220. The local DAA rules may, for example, be based on detailed information on the facilities in and maps of the area/arena together with an awareness of the current usage need for the airspace.

In additional or alternative embodiments, the local DAA rules must comply with the policies for PC5 operations received from the 5^{th} Generation Core (“5GC”) or being preconfigured in the UE.

In additional or alternative embodiments, the AAM 210 is able to scan the airspace of the area/arena for drones (e.g., UAVs 220) by making use of upward pointing radars and cameras.

In additional or alternative embodiments, the detected UAVs are identified by their coordinates and Remote ID as retrieved by a Broadcast Remote ID (“BRID”) or Network Remote ID (“NRID”) mechanisms. In additional or alternative embodiments, the Remote ID is retrieved from the UAS Service Supplier (“USS”) 240 based on the coordinates of the UAV 220.

In additional or alternative embodiments, based on the retrieved Remote ID, the AAM establishes PC5 communication with each detected UAV 220.

In additional or alternative embodiments, the AAM 210 uses PC5 to provide each UAS present in the arena/area with local DAA policies. As an example this might be used to prevent news drones from running into each other or facility details.

In additional or alternative embodiments, a UAV 220 that receives local DAA related policies from an the AAM 210 over PC5 can forward the policies to its UAV-C 230. The policies may be provided as a transparent container to the UAV 220 with the UAV-C 230 as final receiver. In some examples, a UAV-C 230 that receives local policies for DAA from an AAM 210, can steer the UAV 220 accordingly by use of command and control (“C2”) communication in order to enforce the local policies and avoid collisions. In additional or alternative examples, the UAV-C that receives local policies for DAA from an AAM 210, may inform the AAM 210 of its network address (e.g., internet protocol (“IP”) address or uniform resource locator (“URL”)) to enable direct AAM to UAV-C 230 communication via the DN 250.

In additional or alternative embodiments, UAVs 220 using different public land mobile networks PLMNs can be supported. In additional or alternative embodiments, both Long Term Evolution (“LTE”) PC5 and New Radio (“NR”) PC5 are supported.

In additional or alternative embodiments, a UAS (e.g., the UAV 220 and its UAV-C 230) may for C2 communication use either direct communication over PC5 or Uu communication via the 3GPP system

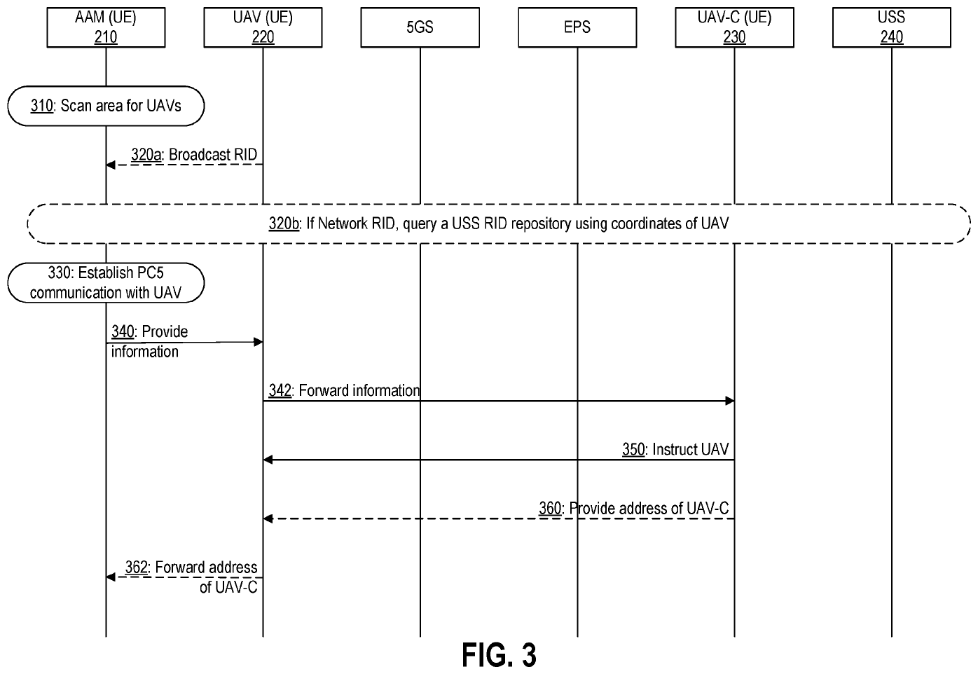

FIG. 3 illustrates an example of signals communicated as part of a DAA procedure.

At block 310, The AAM 210 scans the airspace over the area for drones (e.g., UAV 220) and detects their coordinates. For example, the AAM 210 determines coordinates for UAV 220 by using an upward pointing radar and camera.

At blocks 320a-b, the AAM 210 determines a remote ID (“RID”) associated with the detected UAV 220. At block 320a, the AAM 210 receives the RID directly from the UAV 220 as a Broadcast Remote ID (“BRID”) using PC5 or other means. At block 320b, the AAM 210 determines the ID by querying USS 240 (a RID repository) based on the coordinates of the detected UAV 220.

At block 330, the AAM 210 establishes PC5 communication with the UAV 220 based on the RID.

At block 340, the AAM 210 provides information to the UAV 220 via the PC5 interface. In some embodiments, the information includes local DAA policies for the detected UAV 220 based on the current UAV traffic situation and local info and plans for the area/arena. At block 342, the information can then be forwarded by the UAV 220 to the UAV-C 230. In some examples, the information may be provided as a transparent container to the UAV.

At block 350, The UAV-C 320 considers the local policies received from the AAM 210 and provides instructions (e.g., steering instructions) to the UAV 220 via C2 communication.

At block 360 and block 362, The UAV-C 320 may inform the AAM 210 of its address (e.g., an internet protocol (“IP”) address or a universal resource locator (“URL”)) to enable direct AAM 210 to UAV-C 230 communication via a Data Network. As illustrated, in some examples, the UAV-C 230 may transmit the address to the AAM 210 via the UAV 220. In other examples, the AAM 210 may have provided an address of the AAM 210 to the UAV-C 230 (e.g., in blocks 340, 342), and the UAV-C 230 may provide the address of the UAV-C 230 directly to the AAM 210. In some embodiments, the AAM 210 may provide subsequent information directly to the UAV-C 230.

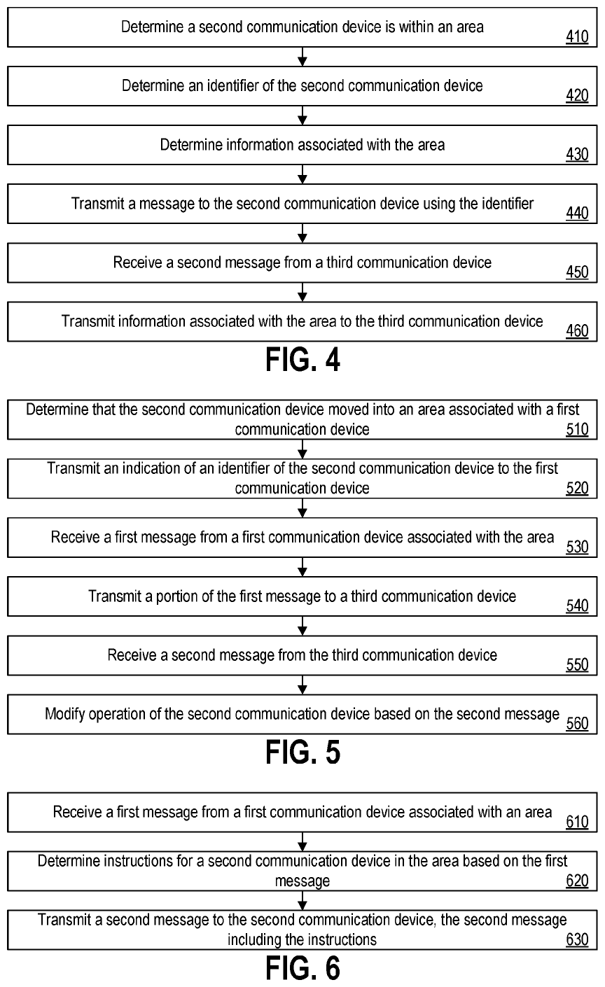

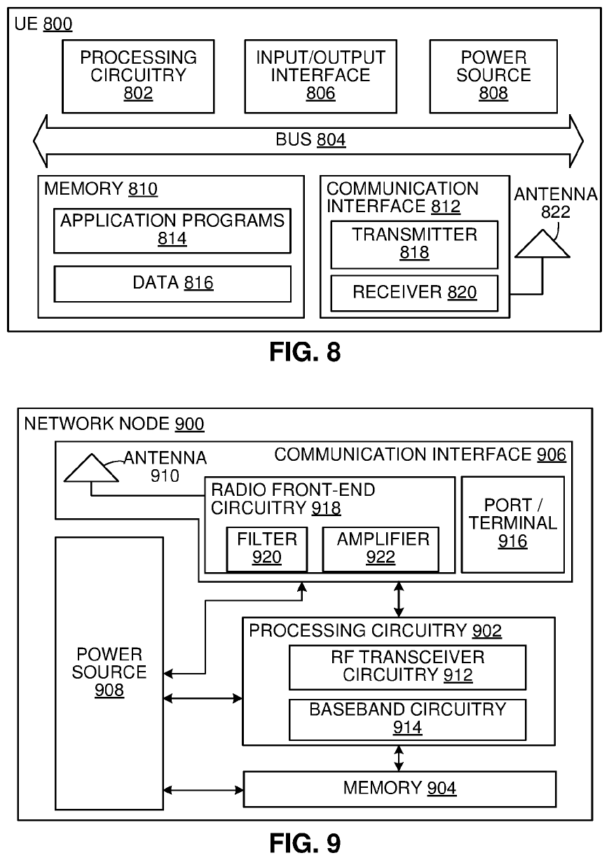

In the description that follows, while the communication device may be any of the wireless device 712A, 712B, wired or wireless devices UE 712C, UE 712D, UE 800, virtualization hardware 1104, virtual machines 1108A, 1108B, UE 1206, AAM 210, UAV 220, or UAV-C 230, the UE 800 (also referred to herein as communication device 800) shall be used to describe the functionality of the operations of the communication device. Operations of the communication device 800 (implemented using the structure of the block diagram of FIG. 8) will now be discussed with reference to the flow charts of FIGS. 4-6 according to some embodiments of inventive concepts. For example, modules may be stored in memory 810 of FIG. 8, and these modules may provide instructions so that when the instructions of a module are executed by respective communication device processing circuitry 802, processing circuitry 802 performs respective operations of the flow charts.

FIG. 4 illustrates an example of operations performed by a first communication device (e.g., an area airspace manager (“AAM”)).

At block 410, processing circuitry 802 determines a second communication device is within an area. In some embodiments, determining the second communication device is within the area includes scanning the area using at least one of: a radar system; and a camera system.

At block 420, processing circuitry 802 determines an identifier of the second communication device. In some embodiments, determining the identifier of the second communication device includes receiving a message from the second communication device, the message including the identifier. In additional or alternative embodiments, receiving the message includes receiving the message via at least one of: a broadcast message; and a short-range wireless message.

In additional or alternative embodiments, determining the identifier of the second communication device includes: determining a location of the second communication device; transmitting a first message to a database via a communications network, the first message including an indication of the location and a request for the identifier; and responsive to transmitting the first message, receiving a second message from the database, the second message including an indicator of the identifier.

At block 430, processing circuitry 802 determines information associated with the area. In some embodiments, the information associated with the area includes at least one of: information associated with other communication devices within the area; information associated with structures and/or obstacles in the area; information associated with operating policies in the area; and local detect and avoid, DAA, policies.

At block 440, processing circuitry 802 transmits, via communication interface 812, a message to the second communication device using the identifier. In some embodiments, transmitting the message includes transmitting an indication that the second communication device forward the message to a third communication device associated with the second communication device. In additional or alternative embodiments, transmitting the message includes transmitting information to the second communication device using an identifier of the second communication device. In some examples, transmitting the information to the second communication device includes transmitting the information to the second communication device via a PC5 interface.

At block 450, processing circuitry 802 receives, via communication interface 812, a second message from a third communication device. In some embodiments, the second message includes an indication of an address associated with the third communication device.

In additional or alternative embodiments, receiving the second message includes receiving the second message from the third communication device via the second communication device.

In additional or alternative embodiments, the first message includes an indication of an address of the first communication device, and receiving the second message includes receiving the second message from the third communication device via a path through a communications network, the path excluding the second communication device.

At block 460, processing circuitry 802 transmits, via communication interface 812, information associated with the area to the third communication device.

In some embodiments, the first communication device includes an AAM. In additional or alternative embodiments, the second communication device includes a UAV. In additional or alternative embodiments, the third communication device includes a UAV-C. In additional or alternative embodiments, the UAV-C and the UAV being part of an unmanned aerial system, UAS. In additional or alternative embodiments, the area includes at least one of: an arena; and an event space.

Various operations of FIG. 4 may be optional. For example, in regards to Embodiment 1 below, blocks 430, 450, and 460 of FIG. 4 may be optional.

FIG. 5 illustrates an example of operations performed by a second communication device (e.g., an unmanned aerial vehicle (“UAV”)).

At block 510, processing circuitry 802 determines that the second communication device moved into an area associated with a first communication device.

At block 520, processing circuitry 802 transmits, via communication interface 812, an indication of an identifier of the second communication device to the first communication device. In some embodiments, transmitting the identifier includes transmitting the indication of the identifier using at least one of: a broadcast message; and a short-range wireless message.

At block 530, processing circuitry 802 receives, via communication interface 812, a first message from a first communication device associated with the area. In some embodiments, receiving the first message includes receiving the first message in response to transmitting the identifier. In additional or alternative embodiments, receiving the first message includes receiving the first message via a PC5 interface.

At block 540, processing circuitry 802 transmits, via communication interface 812, a portion of the first message to a third communication device.

At block 550, processing circuitry 802 receives, via communication interface 812, a second message form the third communication device. In some embodiments, the second message includes at least one of: information associated with other communication devices within the area; information associated with structures and/or obstacles in the area; information associated with operating policies in the area; and local detect and avoid, DAA, policies.

At block 560, processing circuitry 802 modifies operation of the second communication device based on the second message.

In some embodiments, the first communication device includes an AAM. In additional or alternative embodiments, the second communication device includes a UAV. In additional or alternative embodiments, the third communication device includes a UAV-C. In additional or alternative embodiments, the UAV-C and the UAV being part of an unmanned aerial system, UAS. In additional or alternative embodiments, the area includes at least one of: an arena; and an event space.

Various operations of FIG. 5 may be optional. For example, in regards to Embodiment 1 below, blocks 510 and 520 of FIG. 5 may be optional.

FIG. 6 illustrates an example of operations performed by a third communication device (e.g., a UAV controller (“UAV-C”)).

At block 610, processing circuitry 802 receives, via communication interface 812, a first message from a first communication device associated with an area. In some embodiments, receiving the first message from the first communication device comprises receiving the first message from the first communication device via the second communication device.

In additional or alternative embodiments, the first message includes information associated with the area. In some examples, the information includes at least one of: information associated with other communication devices within the area; information associated with structures and/or obstacles in the area; information associated with operating policies in the area; and local detect and avoid, DAA, policies.

At block 620, processing circuitry 802 determines instructions for a second communication device in the area based on the first message.

At block 630, processing circuitry 802 transmits, via communication interface 812, a second message to the second communication device, the second message including the instructions.

In some embodiments, the first communication device includes an AAM. In additional or alternative embodiments, the second communication device includes a UAV. In additional or alternative embodiments, the third communication device includes a UAV-C. In additional or alternative embodiments, the UAV-C and the UAV being part of an unmanned aerial system, UAS. In additional or alternative embodiments, the area includes at least one of: an arena; and an event space.

Various operations of FIG. 6 may be optional.

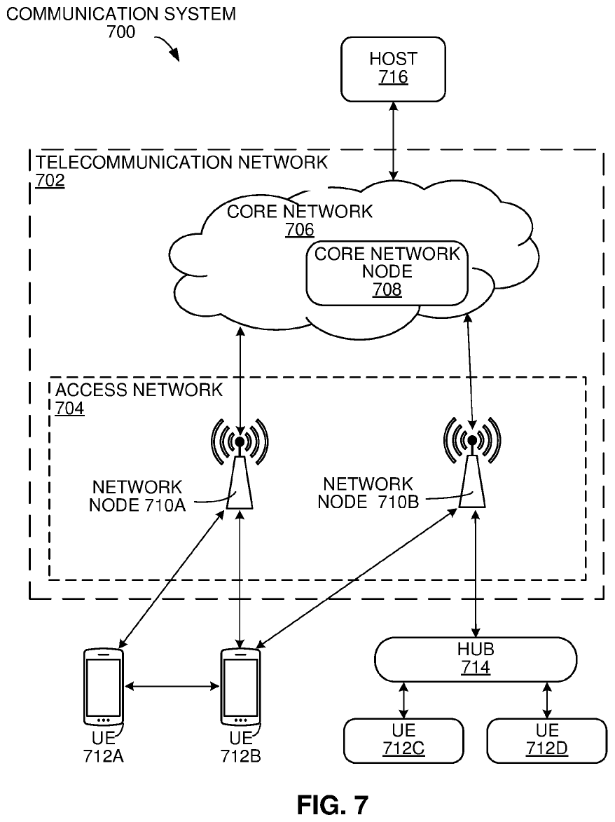

FIG. 7 shows an example of a communication system 700 in accordance with some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3^{rd} Generation Partnership Project (3GPP) access node or non-3GPP access point. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

FIG. 8 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3^{rd} Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

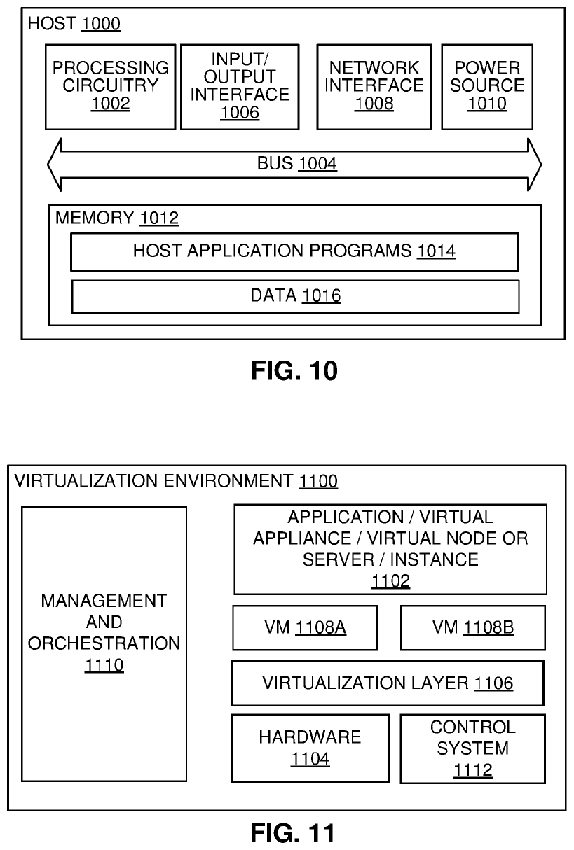

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g. such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

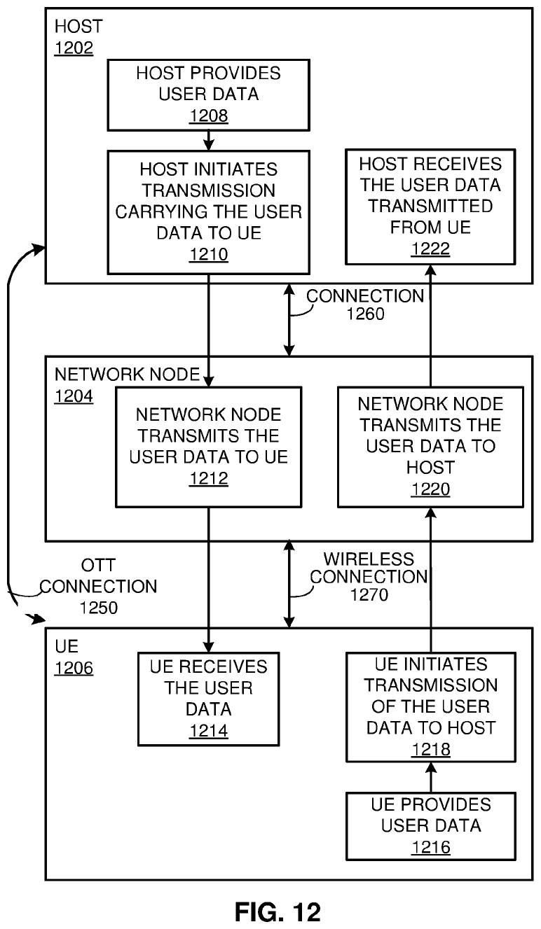

FIG. 12 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. More precisely, the teachings of these embodiments may allow a ground based system to provide information associated with a specific area to a UAS including a UAV in the specific area.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve.

There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method of operating a first communication device, the method comprising:
determining a second communication device is within an area;
determining an identifier of the second communication device; and
transmitting a message to the second communication device using the identifier.

2. The method of claim 1, wherein the first communication device comprises an area airspace manager, AAM,
wherein the second communication device comprises a unmanned aerial vehicle, UAV, and
wherein the determining determines the second communication device is within at least one of:
an arena; and
an event space.

3. The method of claim 1, wherein determining the second communication device is within the area comprises scanning the area using at least one of:
a radar system; and
a camera system.

4. The method of claim 1, wherein determining the identifier of the second communication device comprises:
receiving a message from the second communication device, the message including the identifier.

5. The method of claim 4, wherein receiving the message comprises receiving the message via at least one of:
a broadcast message; and
a short-range wireless message.

6. The method of claim 1, wherein determining the identifier of the second communication device comprises:
determining a location of the second communication device;
transmitting a first message to a database via a communications network, the first message including an indication of the location and a request for the identifier; and
responsive to transmitting the first message, receiving a second message from the database, the second message including an indicator of the identifier.

7. The method of claim 1, wherein transmitting the message comprises transmitting an indication that the second communication device is to forward the message to a third communication device associated with the second communication device.

8. The method of claim 7, wherein the message comprises a first message,
the method further comprising:
receiving a second message from the third communication device associated with the second communication device, the second message including an indication of an address associated with the third communication device.

9. The method of claim 8, wherein receiving the second message comprises receiving the second message from the third communication device via the second communication device.

10. The method of claim 8, wherein the first message comprises an indication of an address of the first communication device, and
wherein receiving the second message comprises receiving the second message from the third communication device via a path through a communications network, the path excluding the second communication device.

11. The method of claim 8, further comprising:
determining information associated with the area; and
transmitting information associated with the area to the third communication device using the address associated with the third communication device.

12. The method of claim 7, wherein the third communication device comprises an unmanned aerial vehicle controller, UAV-C, the UAV-C and the UAV being part of an unmanned aerial system, UAS.

13. The method of claim 1, further comprising
determining information associated with the area,
wherein transmitting the message comprises transmitting the information to the second communication device using the identifier.

14. The method of claim 13, wherein transmitting the information to the second communication device comprises transmitting the information to the second communication device via a PC5 interface.

15. The method of claim 13, wherein the information associated with the area comprises at least one of:
information associated with other communication devices within the area;
information associated with structures and/or obstacles in the area;
information associated with operating policies in the area; and
local detect and avoid, DAA, policies.

16. A method of operating a second communication device, the method comprising:
receiving a first message from a first communication device associated with an area;
transmitting a portion of the first message to a third communication device;
responsive to transmitting the portion of the first message, receiving a second message from the third communication device; and
modifying operation of the second communication device based on the second message.

17. The method of claim 16, wherein the first communication device comprises an area airspace manager, AAM,
wherein the second communication device comprises a unmanned aerial vehicle, UAV,
wherein the third communication device comprises an unmanned aerial vehicle controller, UAV-C, the UAV-C and the UAV being part of an unmanned aerial system, UAS, and
wherein the area includes at least one of:
an arena; and
an event space.

18. The method of claim 16, further comprising:
moving into the area associated with the first communication device; and
transmitting an indication of an identifier of the second communication device to the first communication device,
wherein receiving the first message comprises receiving the first message in response to transmitting the identifier.

19. The method of claim 18, wherein transmitting the identifier comprises transmitting the indication of the identifier using at least one of:
a broadcast message; and
a short-range wireless message.

20. The method of claim 16, wherein receiving the first message comprises receiving the first message via a PC5 interface.

21. The method of claim 16, wherein the second message comprises at least one of:
information associated with other communication devices within the area;
information associated with structures and/or obstacles in the area;
information associated with operating policies in the area; and
local detect and avoid, DAA, policies.

22. A method of operating a third communication device, the method comprising:
receiving a first message from a first communication device associated with an area;
responsive to receiving the first message, determining instructions for operating a second communication device in the area based on the first message; and
transmitting a second message to the second communication device, the second message including the instructions.

23. The method of claim 22, wherein the first communication device comprises an area airspace manager, AAM,
wherein the second communication device comprises a unmanned aerial vehicle, UAV,
wherein the third communication device comprises an unmanned aerial vehicle controller, UAV-C, the UAV-C and the UAV being part of an unmanned aerial system, UAS, and
wherein the area includes at least one of:
an arena; and
an event space.

24. The method of claim 22, wherein receiving the first message from the first communication device comprises receiving the first message from the first communication device via the second communication device.

25. The method of claim 22, wherein the first message comprises information associated with the area, the information comprising at least one of:
information associated with other communication devices within the area;
information associated with structures and/or obstacles in the area;
information associated with operating policies in the area; and
local detect and avoid, DAA, policies.

26-29. (canceled)
